(19) United States
(12) Patent Application Publication
(10) Pub. No.: US 2008/0175204 A1
(43) Pub. Date: Jul. 24, 2008

(54) Method of enhancing continuous packet connectivity in a wireless communications system and related apparatus

(75) Inventor: Yu-Chih Jen, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: Innovative Sonic Limited, Tortola (VG)

(21) Appl. No.: 12/010,286

(22) Filed: Jan. 23, 2008

Related U.S. Application Data
(60) Provisional application No. 60/886,292, filed on Jan. 23, 2007.

(51) Int. Cl. H04Q 7/00

(52) U.S. Cl. 370/331; 370/328

(57) ABSTRACT

A method for enhancing continuous packet connectivity or a discontinuous operation, including a discontinuous packet function, in a user equipment of a wireless communications system includes activating the discontinuous packet function, and stopping the discontinuous packet function and reverting to a continuous packet processing status when an uplink capability of the user equipment is restricted

### CROSS REFERENCE TO RELATED APPLICATIONS

This application claims the benefit of U.S. Provisional Application No. 60/886,292, filed on Jan. 23, 2007 and entitled “Method and Apparatus to realize Continuous Packet Connectivity and improve discontinuous transmission and reception”, the contents of which are incorporated herein by reference.

### BACKGROUND OF THE INVENTION

1. Field of the Invention

The present invention relates to a method of enhancing continuous packet connectivity in a wireless communications system and related apparatus, and more particularly, to a method and related communications apparatus for avoiding system malfunction, so as to enhance CPC.

2. Description of the Prior Art

The third generation (3G) mobile telecommunications system has adopted a Wideband Code Division Multiple Access (WCDMA) wireless air interface access method for a cellular network. WCDMA provides high frequency spectrum utilization, universal coverage, and high quality, high-speed multimedia data transmission. The WCDMA method also meets all kinds of QoS requirements simultaneously, providing diverse, flexible, two-way transmission services and better communication quality to reduce transmission interruption rates. Through the 3G mobile telecommunications system, a user can utilize a wireless communications device, such as a mobile phone, to realize real-time video communications, conference calls, real-time games, online music broadcasts, and email sending/receiving. However, these functions rely on fast, instantaneous transmission. Thus, targeting at the third generation mobile telecommunication technology, the prior art provides High Speed Package Access (HSPA) technology, which includes High Speed Downlink Package Access (HSDPA) and High Speed Uplink Package Access (HSUPA), to increase bandwidth utility rate and package data processing efficiency to improve uplink/downlink transmission rate. For HSDPA and HSUPA, the 3rd Generation Partnership Project (3GPP) provides a Continuous Packet Connectivity (CPC) protocol specification, which includes features that, for user equipments (UEs) in CELL_DCH state, aim to significantly increase the number of packet data users for a cell, reduce the uplink noise rise and improve the achievable download capacity for VoIP.

For an HSDPA UE, physical channels include a high speed physical downlink shared channel (HS-PDSCH), for transferring payload data, and a high speed physical control channel (HS-DPCCH) for uploading an acknowledgement/negative acknowledgement (ACK/NACK) and a channel quality identifier (CQI). As for the media access control (MAC) layer of the HSDPA UE, a MAC-hs entity utilizes a transport channel of High Speed Downlink Shared Channel (HS-DSCH) for receiving data from the physical layer. In addition, a shared control channel for HS-DSCH (HS-SCCH) is used as a physical downlink channel, responsible for transmission of control signals corresponding to HS-DSCH, such as demodulation information.

For an HSUPA UE, physical channels includes two uplink channels: an enhanced dedicated transport channel dedicated physical data channel (E-DPDCH), for transferring payload data, and an E-DCH dedicated physical control channel (E-DPCCH) for transmission of control signals, such as retransmission numbers. Furthermore, a bundle of downlink physical channels are employed in the HSUPA system and used for transmitting control signals associated with grants, ACKs and etc. The downlink physical channels include E-DCH relative grant channel (E-RGCH), E-DCH absolute grant channel (E-AGCH), E-DCH HARQ acknowledgement indicator channel (E-HICH) and fractional dedicated physical channel (F-DPCH). As for the MAC layer of the HSUPA UE, a MAC-e/es entity utilizes a transport channel of enhanced dedicated transport channel (E-DCH) for transmitting MAC packet data to the physical layer with supporting a transmission time interval (TTI) of 10 milliseconds (ms) or 2 ms.

For CELL_DCH state, CPC operation defines an active state and an inactive state. For any data channels (ex. E-DCH), the active state represents that there are data packets transmitted on the data channels. For any control channels (ex. HS-DPCCH), the active state represents that there are data packets transmitted on the data channels corresponding to the control channels, such as HS-PDSCH corresponding to HS-DPCCH. On the contrary, for any data channels, the inactive state represents that there are no data packets transmitted on the data channels. For any control channels, the inactive state represents that there are no data packets transmitted on the data channels corresponding to the control channels.

According to the CPC protocol specification, discontinuous uplink transmission (uplink DTX) is a mechanism where control signals are transmitted on the uplink control channels according to defined discontinuous patterns during the inactive state of corresponding uplink data channels in order to maintain signal synchronization and power control loop with less control signaling. The uplink control channels include a normal DPCCH in addition to the abovementioned uplink control channels of HSUPA and HSDPA.

Moreover, discontinuous uplink reception (uplink DRX) of CPC is utilized to control the UE to transmit E-DCH in specific time interval and has to be configured with uplink DTX. If there has been no E-DCH transmission for a configurable number of transmission time intervals (ex. the interval of UE_Inactivity_Threshold), a radio network controller (RNC) can configure the UE to restrict the start of E-DCH transmission to a MAC_DTX_cycle pattern. UE_DTX_DRX_Offset is also used in uplink DRX, allowing the UEs to have different E-DCH start time.

Furthermore, discontinuous downlink reception (downlink DRX) of CPC is configured by the RNC and allows the UE to restrict the downlink reception times in order to reduce power consumption. When the downlink DRX is enabled, the UE is not required to receive physical downlink channels except for several specific situations.

In addition, CPC includes an HS-SCCH less operation, which is a special mode of HSDPA operation for reducing HS-SCCH overhead for a hybrid automatic repeat request (HARQ) process, thereby reducing UE power consumption. Under this mode, the first HS-DSCH transmission of the HARQ process corresponding to small transport blocks (TBs) on pre-defined HS-DSCH is performed without accompaniment of HS-SCCH signaling, and the HARQ retransmissions corresponding to the first HS-DSCH transmission are accompanied with the HS-SCCH signaling if the retransmissions are needed. Accordingly, the UE needs blind decoding for TB data of the first transmission based on predefined TB size and channel coding set. If blind decoding is success, the UE reports ACK to the base station, also known Node-B, through HS-SCCH; otherwise, the UE reports nothing and waits for retransmission initiated by the Node-B. In order to combine the first transmission with the subsequent retransmissions, the HS-SCCH transmits required control signals of physical channel coding set, TB size, UE identity, a pointer and etc., where the pointer notify the UE of the TTI where the previous transmission has been performed. In addition, The UE can report ACK or NACK for the retransmission, and the retransmission is restricted to two times. The first and second retransmissions can be asynchronous with respect to the first transmission, and with respect to each other. The accompanying HS-SCCH follows the same timing relationship with the HS-PDSCH transmission as legacy transmissions do.

Assume that originally uplink DTX and downlink DRX/uplink DRX were configured and enable by higher layers and haven't received any deactivation command from Node B. According to the related communications protocols, if UE is restricted (not allowed to send uplink transmission or cannot be send normally or regularly) for its uplink activity due to resource allocation changes or being treated with certain application or service, there is no way to maintain the UE to perform CPC operations correctly, even if similar DTX and DRX features are inherited for future communication systems. In addition, it's not specified the configuration procedure of DTX and DRX operation during handover. During handover, inconsistent configuration might exist between UE and new radio network area control entity, which may even, doesn't support CPC feature. On the other hand, if timing changes during handover was not taken into account for CPC configuration, the timing relationship may be inconsistent after handover.

### SUMMARY OF THE INVENTION

According to the present invention, a method for enhancing continuous packet connectivity or a discontinuous operation, comprising a discontinuous packet function, in a user equipment of a wireless communications system comprises activating the discontinuous packet function, and stopping the discontinuous packet function and reverting to a continuous packet processing status when an uplink capability of the user equipment is restricted.

According to the present invention, a method for enhancing continuous packet connectivity or a discontinuous operation, comprising a discontinuous packet function, in a user equipment of a wireless communications system comprises performing a handover process, and stopping the discontinuous packet function before the handover process.

According to the present invention, a method for enhancing continuous packet connectivity or a discontinuous operation in a network of a wireless communications system comprises triggering a handover process of a user equipment, and resetting configurations of the continuous packet connectivity function or the discontinuous operation of the user equipment.

According to the present invention, a method for enhancing continuous packet connectivity or a discontinuous operation, comprising a discontinuous packet function, in a network of a wireless communications system comprises a user equipment operated in a configuration mode for configuring the discontinuous packet function, and transmitting a message to the user equipment to configure the discontinuous packet function when the user equipment performs a handover process.

According to the present invention, a method for enhancing continuous packet connectivity or a discontinuous operation, comprising a discontinuous packet function, in a user equipment of a wireless communications system comprises triggering the discontinuous packet function, and reverting to a continuous transmission mode and using a predefined scheduling a specified period before or when performing a handover process according to predefined information.

According to the present invention, a communications device for enhancing continuous packet connectivity or a discontinuous operation, comprising a discontinuous packet function in a wireless communications system comprises a control circuit for realizing functions of the communications device, a central processing unit installed in the control circuit for executing a program code to operate the control circuit, and a memory coupled to the central processing unit for storing the program code. The program code comprises activating the discontinuous packet function, and stopping the discontinuous packet function and reverting to a continuous packet processing status when an uplink capability of the user equipment is restricted.

According to the present invention, a communications device for enhancing continuous packet connectivity or a discontinuous operation, comprising a discontinuous packet function in a wireless communications system comprises a control circuit for realizing functions of the communications device, a central processing unit installed in the control circuit for executing a program code to operate the control circuit, and a memory coupled to the central processing unit for storing the program code. The program code comprises performing a handover process, and stopping the discontinuous packet function before the handover process.

According to the present invention, a communications device for enhancing continuous packet connectivity or a discontinuous operation, comprising a discontinuous packet function in a wireless communications system comprises a control circuit for realizing functions of the communications device, a central processing unit installed in the control circuit for executing a program code to operate the control circuit, and a memory coupled to the central processing unit for storing the program code. The program code comprises triggering a handover process of a user equipment, and resetting configurations of the continuous packet connectivity function or the discontinuous operation of the user equipment.

According to the present invention, a communications device for enhancing continuous packet connectivity or a discontinuous operation, comprising a discontinuous packet function in a wireless communications system comprises a control circuit for realizing functions of the communications device, a central processing unit installed in the control circuit for executing a program code to operate the control circuit, and a memory coupled to the central processing unit for storing the program code. The program code comprises a user equipment operated in a configuration mode for configuring the discontinuous packet function, and transmitting a message to the user equipment to configure the discontinuous packet function when the user equipment performs a handover process.

According to the present invention, a communications device for enhancing continuous packet connectivity or a discontinuous operation, comprising a discontinuous packet function in a wireless communications system comprises a control circuit for realizing functions of the communications device, a central processing unit installed in the control circuit for executing a program code to operate the control circuit, and a memory coupled to the central processing unit for storing the program code. The program code comprises triggering the discontinuous packet function, and reverting to a continuous transmission mode and using a predefined scheduling a specified period before or when performing a handover process according to predefined information.

According to the present invention, a method for enhancing continuous packet connectivity or a discontinuous operation, comprising a discontinuous packet function, in a wireless communications system comprises a user equipment triggering the discontinuous packet function or the discontinuous operation, and a network controlling the user equipment to stop the discontinuous packet function when the uplink capability of the user equipment is restricted.

According to the present invention, a communications device for enhancing continuous packet connectivity or a discontinuous operation, comprising a discontinuous packet function in a wireless communications system comprises a control circuit for realizing functions of the communications device, a central processing unit installed in the control circuit for executing a program code to operate the control circuit, and a memory coupled to the central processing unit for storing the program code. The program code comprises a user equipment triggering the discontinuous packet function or the discontinuous operation, and a network controlling the user equipment to stop the discontinuous packet function when the uplink capability of the user equipment is restricted.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a communications device.

FIG. 2 is a diagram of the program code shown in FIG. 1.

FIG. 3 to FIG. 8 are flowchart diagrams of processes according to embodiments of the present invention.

### DETAILED DESCRIPTION

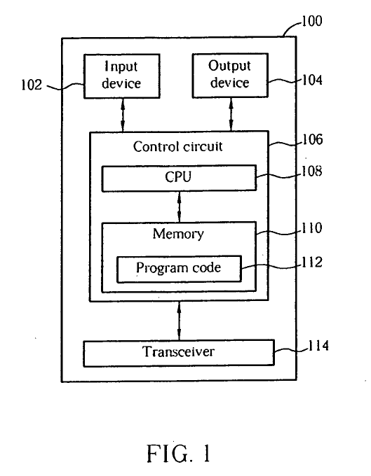

Please refer to FIG. 1, which is a functional block diagram of a communications device 100. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a High Speed Package Access (HSPA) system of the third generation (3G) mobile communications system, LTE system, or other related communications system, and can be user or network equipment.

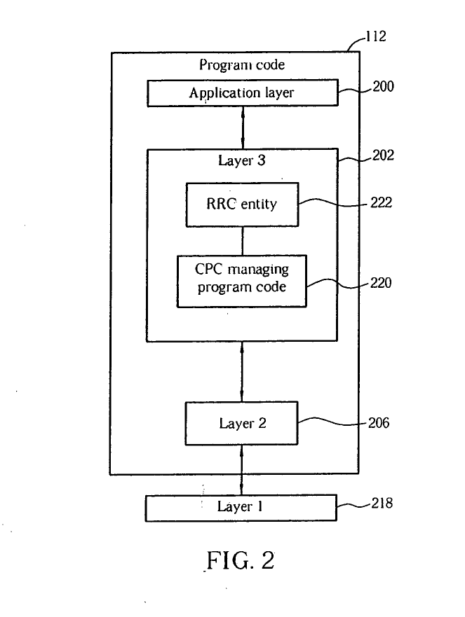

Please continue to refer to FIG. 2. FIG. 2 is a diagram of the program code 112 shown in FIG. 1. The program code 112 includes an application layer 200, a Layer 3 202, and a Layer 2 206, and is coupled to a Layer 1 218. The Layer 3 202 includes a radio resource control (RRC) entity 222, which is used for controlling the Layer 1 218 and the Layer 2 206. In addition, when the communications device 100 implements a user equipment, the RRC entity 222 can change an RRC state according to system requirements or radio conditions, to switch between an RRC_IDLE state and an RRC_CONNECTED state. The RRC_CONNECTED state can be CELL_PCH, URA_PCH, CELL_FACH or CELL_DCH state in 3G system.

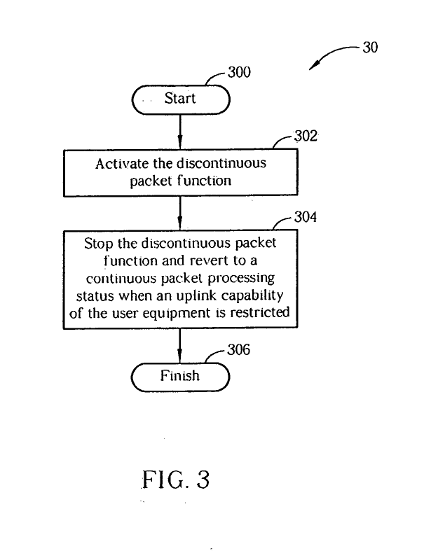

As mentioned above, for UEs in CELL_DCH state, the network can configure CPC to significantly increase the number of packet data users for a cell, reduce the uplink noise rise and improve the achievable download capacity for VoIP. CPC includes mechanisms of uplink DTX, uplink DRX, downlink DRX, and HS-SCCH less operation, for reducing UE power consumption. In such a situation, the embodiment of the present invention provides a CPC managing program code 220 to avoid system malfunction. Please refer to FIG. 3, which illustrates a schematic diagram of a process 30 according to an embodiment of the present invention. The process 30 is utilized for enhancing CPC in a UE of a wireless communications system, and can be compiled into the CPC managing program code 220. The process 30 comprises the following steps:
Step 300: Start.
Step 302: Activate the discontinuous packet function.
Step 304: Stop the discontinuous packet function and revert to a continuous packet processing status when an uplink capability of the user equipment is restricted.
Step 306: Finish.

According to the process 30, after the UE triggers the discontinuous packet function, if an uplink capability of the user equipment is restricted, the UE can stop the discontinuous packet function and revert to a continuous packet processing status.

Preferably, when the uplink capability of the user equipment is restricted and the UE is going to revert to the continuous packet processing status, the UE can (automatically) revert to a continuous transmission state of the continuous packet processing status. In addition, the uplink capability of the user equipment may be restricted by service restriction, application restriction, resource restriction, scheduling restriction, QoS restriction, or synchronization restriction.

Moreover, before reverting to the continuous packet processing status, the UE can report a message to the network to indicate that the uplink capability of the UE is restricted, or ask an acknowledgement message to indicate that the user equipment is capable of reverting to the continuous packet processing status before reverting to the continuous packet processing status. Beside, if the UE receives an initiation command for triggering the discontinuous packet function from a network, the UE can discard the initiation command, and restrict operation of the continuous packet processing status according to predefined rules after reverting to the continuous packet processing status.

In short, via the process 30, the embodiment of the present invention can stop the discontinuous packet function and revert to a continuous packet processing status when an uplink capability of the user equipment is restricted.

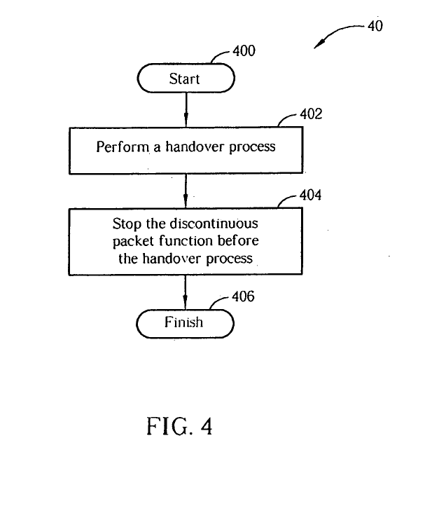

Please refer to FIG. 4, which illustrates a schematic diagram of a process 40 according to an embodiment of the present invention. The process 40 is utilized for enhancing CPC in a UE of a wireless communications system, and can be compiled into the CPC managing program code 220. The process 40 comprises the following steps:
Step 400: Start.
Step 402: Perform a handover process.
Step 404: Stop the discontinuous packet function before the handover process.
Step 406: Finish.

According to the process 40, when a UE performs a handover process, the embodiment of the present invention stops the discontinuous packet function of the UE before the handover process. As a result, when the UE perform handover from a base station supporting the CPC function to a base station not supporting the CPC function, the embodiment of the present invention stops the discontinuous packet function of the UE before the handover process, so as to prevent system malfunction.

Preferably, the embodiment of the present invention can further clear configurations corresponding to the continuous packet connectivity function, or reset the configurations corresponding to the continuous packet connectivity function.

Therefore, via the process 40, the embodiment of the present invention stops the discontinuous packet function of the UE before the handover process.

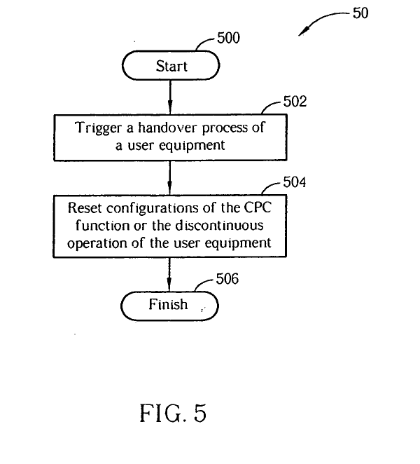

Please refer to FIG. 5, which illustrates a schematic diagram of a process 50 according to an embodiment of the present invention. The process 50 is utilized for enhancing CPC in a network of a wireless communications system, and can be compiled into the CPC managing program code 220. The process 50 comprises the following steps:
Step 500: Start.
Step 502: Trigger a handover process of a user equipment.
Step 504: Reset configurations of the CPC function or the discontinuous operation of the user equipment.
Step 506: Finish.

According to the process 50, after the UE triggers a handover process, the embodiment of the present invention resets configurations of the CPC function or the discontinuous operation of the user equipment.

Preferably, the handover process is a hard handover process, or a timing re-initialized hard handover. Moreover, the embodiment of the present invention can reset a discontinuous transmission function, a discontinuous reception function, a less operation of a control channel, or a restricted operation of a control channel.

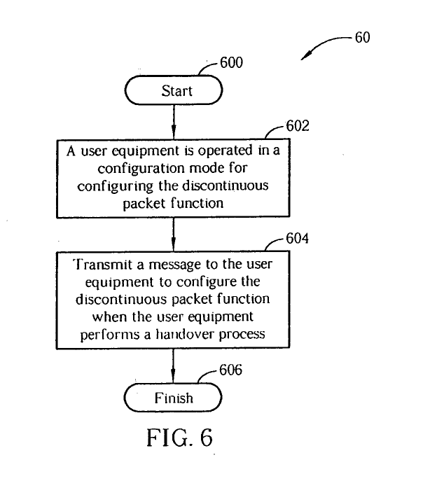

Please refer to FIG. 6, which illustrates a schematic diagram of a process 60 according to an embodiment of the present invention. The process 60 is utilized for enhancing CPC in a network of a wireless communications system, and can be compiled into the CPC managing program code 220. The process 60 comprises the following steps:
Step 600: Start.
Step 602: A user equipment is operated in a configuration mode for configuring the discontinuous packet function.
Step 604: Transmit a message to the user equipment to configure the discontinuous packet function when the user equipment performs a handover process.
Step 606: Finish.

According to the process 60, when the UE is operated in a configuration mode for configuring the discontinuous packet function, the embodiment of the present invention transmits a message to the UE to configure the discontinuous packet function when the user equipment performs a handover process.

Preferably, the message is a radio resource control message from a source base station or a target base station. If the UE receives a command of changing configuration of the discontinuous packet function, the embodiment of the present invention can discard the command and configure the discontinuous packet function according to the message, or determine to configure the discontinuous packet function according to the command or to configure the discontinuous packet function according to the message, according to a receiving order of the command and the message.

Therefore, via the process 60, when the UE is operated in a configuration mode for configuring the discontinuous packet function, the embodiment of the present invention transmits a message to the UE to configure the discontinuous packet function when the user equipment performs a handover process.

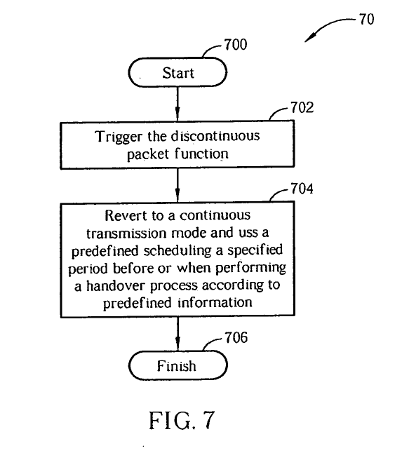

Please refer to FIG. 7, which illustrates a schematic diagram of a process 70 according to an embodiment of the present invention. The process 70 is utilized for enhancing CPC in a UE of a wireless communications system, and can be compiled into the CPC managing program code 220. The process 70 comprises the following steps:
Step 700: Start.
Step 702: Trigger the discontinuous packet function.
Step 704: Revert to a continuous transmission mode and use a predefined scheduling a specified period before or when performing a handover process according to predefined information.
Step 706: Finish.

According to the process 70, after the UE triggers the discontinuous packet function, the embodiment of the present invention control the UE to revert to a continuous transmission mode and use a predefined scheduling a specified period before or when performing a handover process according to predefined information.

Preferably, in the embodiment of the present invention, the predefined information is measurement result, radio resource allocation, handover indication, system broadcast information, stored configuration, or standardized rules. The embodiment of the present invention can indicate a network that the operating mode of the user equipment is changed. The predefined scheduling is used for uplink or downlink transmission for resulting in similar behavior in the continuous transmission mode as in the discontinuous packet function.

Furthermore, the UE can preferably ask the network to send a new configuration of the continuous packet connectivity function before performing the handover process, or update the configuration of the continuous packet connectivity function before performing the handover process according to a specified condition, and send the updated result to a network.

Therefore, via the process 70, after the UE triggers the discontinuous packet function, the embodiment of the present invention control the UE to revert to a continuous transmission mode and use a predefined scheduling a specified period before or when performing a handover process according to predefined information.

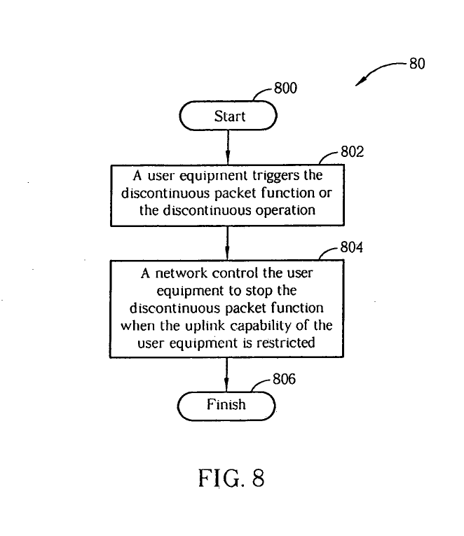

Please refer to FIG. 8, which illustrates a schematic diagram of a process 80 according to an embodiment of the present invention. The process 80 is utilized for enhancing CPC in a wireless communications system, and can be compiled into the CPC managing program code 220. The process 80 comprises the following steps:
Step 800: Start.
Step 802: A user equipment triggers the discontinuous packet function or the discontinuous operation.
Step 804: A network controls the user equipment to stop the discontinuous packet function when the uplink capability of the user equipment is restricted.
Step 806: Finish.

According to the process 80, when the uplink capability of the UE is restricted, the network controls the UE to stop the discontinuous packet function when the uplink capability of the user equipment is restricted. If the user equipment comprises single receiver and receives a multimedia broadcast and multicast service in a dedicated cell, the network does not trigger the discontinuous transmission function of the user equipment or stops the discontinuous transmission function when the user equipment has configured the discontinuous transmission function, or the network or the user equipment can stop or update the discontinuous transmission function when the user equipment has configured the discontinuous transmission function.

Besides, when the UE comprises single receiver and receives a multimedia broadcast and multicast service in a dedicated cell, the embodiment of the present invention can clear configurations corresponding to the discontinuous transmission function or the discontinuous reception function in the user equipment at the same time or respectively.

Moreover, if the user equipment comprises dual receivers and receives a multimedia broadcast and multicast service in a dedicated cell, where the uplink is not allowed and only downlink is possible, the embodiment of the present invention can maintain configurations of the discontinuous transmission function or the discontinuous reception function corresponding to a unicast or multicast service in the user equipment, and adjust the configurations of the discontinuous transmission function or the discontinuous reception function according to the status of the multicast service. In addition, when the unicast service is not stopped, the embodiment of the present invention can switching the configurations of the discontinuous transmission function or the discontinuous reception function corresponding to the multicast service to the configurations of the discontinuous transmission function or the discontinuous reception function corresponding to the unicast service.

In summary, the embodiment of the present invention provides different embodiments for enhancing CPC.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for enhancing continuous packet connectivity or a discontinuous operation, comprising a discontinuous packet function, in a user equipment of a wireless communications system comprising:
activating the discontinuous packet function; and
stopping the discontinuous packet function and reverting to a continuous packet processing status when an uplink capability of the user equipment is restricted.

2. The method of claim 1, wherein the discontinuous packet function comprises a discontinuous reception function or a discontinuous transmission function.

3. The method of claim 1, wherein stopping the discontinuous packet function and reverting to the continuous packet processing status when the uplink capability of the user equipment is restricted is stopping the discontinuous packet function and reverting to a continuous transmission state or a continuous reception state of the continuous packet processing status when the uplink capability of the user equipment is restricted according to predefined rules.

4. The method of claim 3, wherein the predefined rules are requirements for switching to the continuous packet processing status, or to activate the continuous packet processing status, or allowed radio resources or duration, or uplink transmission information.

5. The method of claim 1, wherein stopping the discontinuous packet function and reverting to the continuous packet processing status when the uplink capability of the user equipment is restricted is stopping the discontinuous packet function and automatically reverting to the continuous packet processing status when the uplink capability of the user equipment is restricted.

6. The method of claim 1, wherein the uplink capability of the user equipment is restricted by service restriction, application restriction, resource restriction, scheduling restriction, QoS restriction, or synchronization restriction.

7. The method of claim 1, wherein stopping the discontinuous packet function and reverting to the continuous packet processing status when the uplink capability of the user equipment is restricted comprises reporting a message to a network to indicate that the uplink capability of the user equipment is restricted before reverting to the continuous packet processing status.

8. The method of claim 1, wherein stopping the discontinuous packet function and reverting to the continuous packet processing status when the uplink capability of the user equipment is restricted comprises asking an acknowledgement message to indicate that the user equipment is capable of reverting to the continuous packet processing status before reverting to the continuous packet processing status.

9. The method of claim 1, further comprising discarding an initiation command utilized for triggering the discontinuous packet function after receiving the initiation command from a network.

10. The method of claim 1, further comprising restricting operation of the continuous packet processing status according to predefined rules after reverting to the continuous packet processing status.

11. The method of claim 10, wherein predefined rules are time to recover or restart discontinuous processing function after reverting to the continuous packet processing status, or allowed procedures, or radio resources or duration, or uplink transmission information.

12. A method for enhancing continuous packet connectivity or a discontinuous operation, comprising a discontinuous packet function, in a user equipment of a wireless communications system comprising:
performing a handover process; and
stopping the discontinuous packet function before the handover process.

13. The method of claim 12, wherein the discontinuous packet function comprises a discontinuous reception function or a discontinuous transmission function.

14. The method of claim 12, further comprising clearing configurations corresponding to the continuous packet connectivity function.

15. The method of claim 14, further comprising resetting the configurations corresponding to the continuous packet connectivity function by a network.

16. The method of claim 14, further comprising asking a network to reset the configurations corresponding to the continuous packet connectivity function.

17. A method for enhancing continuous packet connectivity or a discontinuous operation in a network of a wireless communications system comprising:
triggering a handover process of a user equipment; and
resetting configurations of the continuous packet connectivity function or the discontinuous operation of the user equipment.

18. The method of claim 17, wherein the handover process is a hard handover process, or a timing re-initialized hard handover.

19. The method of claim 17, wherein resetting the configurations of the continuous packet connectivity function or the discontinuous operation of the user equipment comprises resetting a discontinuous transmission function, a discontinuous reception function, a less operation of a control channel, or a restricted operation of a control channel.

20. A method for enhancing continuous packet connectivity or a discontinuous operation, comprising a discontinuous packet function, in a network of a wireless communications system comprising:
a user equipment operated in a configuration mode for configuring the discontinuous packet function; and
transmitting a message to the user equipment to configure the discontinuous packet function when the user equipment performs a handover process.

21. The method of claim 20, wherein transmitting the message to the user equipment to configure the discontinuous packet function when the user equipment performs the handover process is transmitting the message to the user equipment by a first base station to configure the discontinuous packet function when the user equipment performs handover from the first base station to a second base station.

22. The method of claim 20, wherein transmitting the message to the user equipment to configure the discontinuous packet function when the user equipment performs the handover process is transmitting the message to the user equipment by a second base station to configure the discontinuous packet function when the user equipment performs handover from a first base station to the second base station.

23. The method of claim 20, wherein the message is a radio resource control message.

24. The method of claim 20, further comprising:
the user equipment receiving a command of changing configuration of the discontinuous packet function; and
discarding the command and configuring the discontinuous packet function according to the message.

25. The method of claim 20, further comprising:
the user equipment receiving a command of changing configuration of the discontinuous packet function; and
determining to configure the discontinuous packet function according to the command or to configure the discontinuous packet function according to the message, according to a receiving order of the command and the message.

26. A method for enhancing continuous packet connectivity or a discontinuous operation, comprising a discontinuous packet function, in a user equipment of a wireless communications system comprising:
triggering the discontinuous packet function; and
reverting to a continuous transmission mode and using a predefined scheduling a specified period before or when performing a handover process according to predefined information.

27. The method of claim 26, wherein the predefined information is measurement result, radio resource allocation, handover indication, system broadcast information, stored configuration, or standardized rules.

28. The method of claim 26, further comprising indicating a network that the operating mode of the user equipment is changed.

29. The method of claim 26, wherein the predefined scheduling results in similar behavior in the continuous transmission mode as in the discontinuous packet function.

30. The method of claim 26, wherein the predefined scheduling is used for uplink or downlink transmission.

31. The method of claim 26, wherein the predefined scheduling is a radio resource allocation or a continuous or half-continuous scheduling allocation.

32. The method of claim 26, further comprising asking a network to send a new configuration of the continuous packet connectivity function before performing the handover process.

33. The method of claim 26, further comprising updating the configuration of the continuous packet connectivity function before performing the handover process according to a specified condition, and sending the updated result to a network.

34. The method of claim 33, wherein the specified condition comprises operating status, channel status, or measurement requirement of the user equipment.

35. A communications device for enhancing continuous packet connectivity or a discontinuous operation, comprising a discontinuous packet function in a wireless communications system comprising:
a control circuit for realizing functions of the communications device;
a central processing unit installed in the control circuit for executing a program code to operate the control circuit; and
a memory coupled to the central processing unit for storing the program code;
wherein the program code comprises:
activating the discontinuous packet function; and
stopping the discontinuous packet function and reverting to a continuous packet processing status when an uplink capability of the user equipment is restricted.

36. The communications device of claim 35, wherein the discontinuous packet function comprises a discontinuous reception function or a discontinuous transmission function.

37. The communications device of claim 35, wherein stopping the discontinuous packet function and reverting to the continuous packet processing status when the uplink capability of the user equipment is restricted is stopping the discontinuous packet function and reverting to a continuous transmission state or a continuous reception state of the continuous packet processing status when the uplink capability of the user equipment is restricted according to predefined rules.

38. The communications device of claim 37, wherein the predefined rules are requirements for switching to the continuous packet processing status, or to activate the continuous packet processing status, or allowed radio resources or duration, or uplink transmission information.

39. The communications device of claim 35, wherein stopping the discontinuous packet function and reverting to the continuous packet processing status when the uplink capability of the user equipment is restricted is stopping the discontinuous packet function and automatically reverting to the continuous packet processing status when the uplink capability of the user equipment is restricted.

40. The communications device of claim 35, wherein the uplink capability of the user equipment is restricted by service restriction, application restriction, resource restriction, scheduling restriction, QoS restriction, or synchronization restriction.

41. The communications device of claim 35, wherein stopping the discontinuous packet function and reverting to the continuous packet processing status when the uplink capability of the user equipment is restricted comprises reporting a message to a network to indicate that the uplink capability of the user equipment is restricted before reverting to the continuous packet processing status.

42. The communications device of claim 35, wherein stopping the discontinuous packet function and reverting to the continuous packet processing status when the uplink capability of the user equipment is restricted comprises asking an acknowledgement message to indicate that the user equipment is capable of reverting to the continuous packet processing status before reverting to the continuous packet processing status.

43. The communications device of claim 35, wherein the program code further comprises discarding an initiation command utilized for triggering the discontinuous packet function after receiving the initiation command from a network.

44. The communications device of claim 35, wherein the program code further comprises restricting operation of the continuous packet processing status according to predefined rules after reverting to the continuous packet processing status.

45. The communications device of claim 43, wherein predefined rules are time to recover or restart discontinuous processing function after reverting to the continuous packet processing status, or allowed procedures, or radio resources or duration, or uplink transmission information.

46. A communications device for enhancing continuous packet connectivity or a discontinuous operation, comprising a discontinuous packet function in a wireless communications system comprising:
a control circuit for realizing functions of the communications device;
a central processing unit installed in the control circuit for executing a program code to operate the control circuit; and
a memory coupled to the central processing unit for storing the program code;
wherein the program code comprises:
performing a handover process; and
stopping the discontinuous packet function before the handover process.

47. The communications device of claim 46, wherein the discontinuous packet function comprises a discontinuous reception function or a discontinuous transmission function.

48. The communications device of claim 46, wherein the program code further comprises clearing configurations corresponding to the continuous packet connectivity function.

49. The communications device of claim 48, wherein the program code further comprises resetting the configurations corresponding to the continuous packet connectivity function by a network.

50. The communications device of claim 48, wherein the program code further comprises asking a network to reset the configurations corresponding to the continuous packet connectivity function.

51. A communications device for enhancing continuous packet connectivity or a discontinuous operation, comprising a discontinuous packet function in a wireless communications system comprising:
a control circuit for realizing functions of the communications device;
a central processing unit installed in the control circuit for executing a program code to operate the control circuit; and
a memory coupled to the central processing unit for storing the program code;
wherein the program code comprises:
triggering a handover process of a user equipment; and
resetting configurations of the continuous packet connectivity function or the discontinuous operation of the user equipment.

52. The communications device of claim 51, wherein the handover process is a hard handover process, or a timing re-initialized hard handover.

53. The communications device of claim 51, wherein resetting the configurations of the continuous packet connectivity function or the discontinuous operation of the user equipment comprises resetting a discontinuous transmission function, a discontinuous reception function, a less operation of a control channel, or a restricted operation of a control channel.

54. The communications device of claim 51, wherein resetting the configurations of the continuous packet connectivity function or the discontinuous operation of the user equipment comprises resetting configurations of a discontinuous transmission function, a discontinuous reception function, a less operation of a control channel, or a restricted operation of a control channel.

55. A communications device for enhancing continuous packet connectivity or a discontinuous operation, comprising a discontinuous packet function in a wireless communications system comprising:
a control circuit for realizing functions of the communications device;
a central processing unit installed in the control circuit for executing a program code to operate the control circuit; and
a memory coupled to the central processing unit for storing the program code;
wherein the program code comprises:
a user equipment operated in a configuration mode for configuring the discontinuous packet function; and
transmitting a message to the user equipment to configure the discontinuous packet function when the user equipment performs a handover process.

56. The communications device of claim 55 being a source base station.

57. The communications device of claim 55, being a target base station.

58. The communications device of claim 55, wherein the message is a radio resource control message.

59. The communications device of claim 55, wherein the program code further comprises:
the user equipment receiving a command of changing configuration of the discontinuous packet function; and
discarding the command and configuring the discontinuous packet function according to the message.

60. The communications device of claim 55, wherein the program code further comprises:
the user equipment receiving a command of changing configuration of the discontinuous packet function; and
determining to configure the discontinuous packet function according to the command or to configure the discontinuous packet function according to the message, according to a receiving order of the command and the message.

61. A communications device for enhancing continuous packet connectivity or a discontinuous operation, comprising a discontinuous packet function in a wireless communications system comprising:
a control circuit for realizing functions of the communications device;
a central processing unit installed in the control circuit for executing a program code to operate the control circuit; and
a memory coupled to the central processing unit for storing the program code;
wherein the program code comprises:
triggering the discontinuous packet function; and
reverting to a continuous transmission mode and using a predefined scheduling a specified period before or when performing a handover process according to predefined information.

62. The communications device of claim 61, wherein the predefined information is measurement result, radio resource allocation, handover indication, system broadcast information, stored configuration, or standardized rules.

63. The communications device of claim 61, wherein the predefined information are standardized rules.

64. The communications device of claim 61, wherein the program code further comprises indicating a network that the operating mode of the user equipment is changed.

65. The communications device of claim 61, wherein the predefined scheduling results in similar behavior in the continuous transmission mode as in the discontinuous packet function.

66. The communications device of claim 61, wherein the predefined scheduling is used for uplink transmission.

67. The communications device of claim 61, wherein the predefined scheduling is used for downlink transmission.

68. The communications device of claim 61, wherein the predefined scheduling is a radio resource allocation or a continuous or half-continuous scheduling allocation.

69. The communications device of claim 61, wherein the program code further comprises asking a network to send a new configuration of the continuous packet connectivity function before performing the handover process.

70. The communications device of claim 61, wherein the program code further comprises updating the configuration of the continuous packet connectivity function before performing the handover process according to a specified condition, and sending the updated result to a network.

71. The communications device of claim 70, wherein the specified condition comprises operating status, channel status, or measurement requirement of the user equipment.

72. A method for enhancing continuous packet connectivity or a discontinuous operation, comprising a discontinuous packet function, in a wireless communications system comprising:
a user equipment triggering the discontinuous packet function or the discontinuous operation; and
a network controlling the user equipment to stop the discontinuous packet function when the uplink capability of the user equipment is restricted.

73. The method of claim 72, wherein discontinuous packet function comprises a discontinuous transmission function or a discontinuous reception function.

74. The method of claim 73, wherein the user equipment comprises single receiver and receives a multimedia broadcast and multicast service in a dedicated cell.

75. The method of claim 74, wherein the network does not trigger the discontinuous transmission function of the user equipment.

76. The method of claim 74, wherein the network stops the discontinuous transmission function when the user equipment has configured the discontinuous transmission function.

77. The method of claim 74, wherein the network or the user equipment stops or updates the discontinuous transmission function when the user equipment has configured the discontinuous transmission function.

78. The method of claim 77, further comprising reporting the status of the discontinuous transmission function by the user equipment.

79. The method of claim 74, further comprising clearing configurations corresponding to the discontinuous transmission function or the discontinuous reception function in the user equipment.

80. The method of claim 79, wherein clearing configurations corresponding to the discontinuous transmission function or the discontinuous reception function in the user equipment is respectively clearing configurations corresponding to the discontinuous transmission function or the discontinuous reception function in the user equipment.

81. The method of claim 74, wherein the user equipment comprises dual receivers and receives a multimedia broadcast and multicast service in a dedicated cell, where the uplink is not allowed and only downlink is possible.

82. The method of claim 81, further comprising maintaining configurations of the discontinuous transmission function or the discontinuous reception function corresponding to a unicast service in the user equipment.

83. The method of claim 81, further comprising maintaining configurations of the discontinuous transmission function or the discontinuous reception function corresponding to a multicast service in the user equipment.

84. The method of claim 83, further comprising adjusting the configurations of the discontinuous transmission function or the discontinuous reception function according to the status of the multicast service.

85. The method of claim 84, further comprising switching the configurations of the discontinuous transmission function or the discontinuous reception function corresponding to the multicast service to the configurations of the discontinuous transmission function or the discontinuous reception function corresponding to a unicast service when the unicast service is not stopped.

86. A communications device for enhancing continuous packet connectivity or a discontinuous operation, comprising a discontinuous packet function in a wireless communications system comprising:
a control circuit for realizing functions of the communications device;
a central processing unit installed in the control circuit for executing a program code to operate the control circuit; and
a memory coupled to the central processing unit for storing the program code;
wherein the program code comprises:
a user equipment triggering the discontinuous packet function or the discontinuous operation; and
a network controlling the user equipment to stop the discontinuous packet function when the uplink capability of the user equipment is restricted.

87. The communications device of claim 86, wherein discontinuous packet function comprises a discontinuous transmission function or a discontinuous reception function.

88. The communications device of claim 87, wherein the user equipment comprises single receiver and receives a multimedia broadcast and multicast service in a dedicated cell.

89. The communications device of claim 88, wherein the network does not trigger the discontinuous transmission function of the user equipment.

90. The communications device of claim 88, wherein the network stops the discontinuous transmission function when the user equipment has configured the discontinuous transmission function.

91. The communications device of claim 88, wherein the network or the user equipment stops or updates the discontinuous transmission function when the user equipment has configured the discontinuous transmission function.

92. The communications device of claim 91, wherein the program code further comprises reporting the status of the discontinuous transmission function by the user equipment.

93. The communications device of claim 88, wherein the program code further comprises clearing configurations corresponding to the discontinuous transmission function or the discontinuous reception function in the user equipment.

94. The communications device of claim 93, wherein clearing configurations corresponding to the discontinuous transmission function or the discontinuous reception function in the user equipment is respectively clearing configurations corresponding to the discontinuous transmission function or the discontinuous reception function in the user equipment.

95. The communications device of claim 87, wherein the user equipment comprises dual receivers and receives a multimedia broadcast and multicast service in a dedicated cell, where the uplink is not allowed and only downlink is possible.

96. The communications device of claim 95, wherein the program code further comprises maintaining configurations of the discontinuous transmission function or the discontinuous reception function corresponding to a unicast service in the user equipment.

97. The communications device of claim 95, wherein the program code further comprises maintaining configurations of the discontinuous transmission function or the discontinuous reception function corresponding to a multicast service in the user equipment.

98. The communications device of claim 97, wherein the program code further comprises adjusting the configurations of the discontinuous transmission function or the discontinuous reception function according to the status of the multicast service.

99. The communications device of claim 98, wherein the program code further comprises switching the configurations of the discontinuous transmission function or the discontinuous reception function corresponding to the multicast service to the configurations of the discontinuous transmission function or the discontinuous reception function corresponding to a unicast service when the unicast service is not stopped.
